(19) United States
(12) Patent Application Publication
(10) Pub. No.: US 2005/0047409 A1
(43) Pub. Date: Mar. 3, 2005

(54) Interface providing device

(75) Inventors: Takeshi Kawasaki, Kawasaki (JP); Naoki Oguchi, Kawasaki (JP); Tetsumei Tsuruoka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/887,901

(22) Filed: Jul. 12, 2004

(30) Foreign Application Priority Data
Aug. 28, 2003 (JP) 2003-209266

(51) Int. Cl. H04L 12/56

(52) U.S. Cl. 370/389

(57) ABSTRACT

Interface identifying information related to an individual processing device and forwarding information related to the processing device are received from the processing device, interface identifying information and forwarding information related to a processing device accessible on a network are retained, an access packet is received from a terminal that accesses the accessible processing device, access packet identifying information related to the access packet is compared with the interface identifying information and the forwarding information, the access packet is forwarded to the accessible processing device.

### BACKGROUND OF THE INVENTION

The invention relates to an interface providing technology for a server for application service on a network.

Generally, in a conventional packet processing device, the same device executes processes such as providing network interfaces and terminating a packet, and so on. Therefore, a packet process according to an interface category on a network such as Ethernet (registered trademark) which uses ARP (Address Resolution Protocol) and the Internet using PPP (Point-to-Point Protocol), etc., is determined in accordance with performance of a packet processing device. Further, a throughput for a packet routing process between the interfaces is determined according to the performance of the packet processing device. Moreover, throughputs for a control protocol and a service application are determined based on the performance of the packet processing device.

Then, normally, under such a condition that the throughputs for the control protocol and the service application become deficient, the following approaches are to be taken.

If the same device executes processes such as providing the network interfaces and terminating the packet, there is given a method of separating servers for providing applications according to the application.

Further, a method of installing a layer-4 switch on the network side is given by way of the solution. At this time, an operator manually sets configuration information of the server that executes each application. Then, on such a network, the packet from a terminal that accesses the application via the network is forwarded to the application executing server in accordance with layer-4 switch configuration information such as a TCP (Transmission Control Protocol)-based port number, etc.

By the way, there have hitherto been disclosed technologies (refer to, e.g., Japanese Patent Application Laid-Open Publication No. 9-3313559) for facilitating connection management by an administrator and assuring a communication quality of each connection.

There were the following problems inherent in the conventional technology by which the same packet processing device executes the processes such as providing the network interfaces and terminating the packet. A demand for the throughput of the packet processing device is depending on a position in the network where the packet processing device is installed. To be specific, the demand for the throughput of the packet processing device differs in terms of a throughput of routing and/or forwarding between the interfaces according to the interface category and a throughput for the application. Accordingly, in this case, the packet processing device having a proper throughput was not necessarily installed in a proper position.

Further, if the performance of processing control protocol (e.g. for routing) is deficient in the packet routing device, an erroneous routing process occurs.

With the result of the packet routing device an extra load is applied onto the network inducing congestion. The congestion induced might greatly affect the whole network such as causing faults, etc. in the worst case. Hence, for preventing the deficiency of the throughput of the processing control protocol, the device has been generally designed based on an excessive throughput that assumes the worst case in the network. In the normal case, however, the excessive throughput was futile.

Further, the method involving the use of the layer-4 switch in the prior arts required an operator to perform manual setting by operating the layer-4 switch through an operation interface as the case might be. The case where the operator performs the manual setting is a case in which the server starts providing a new application service or terminates providing the application service, or fault occurred with the machine providing the service and restart the application service at a different server. Therefore, in the case of conducting those setting operations, time and staffing were needed.

### SUMMARY OF THE PRESENT INVENTION

The invention was devised in view of the items described above and aims at solving the problems by facilitating the provision of the interfaces and the forwarding of the access packet in accordance with the interface information given from the processing device and with the access packet from the terminal that accesses the application service.

The invention adopts the following means in order to solve the problems.

Namely, interface identifying information related to an individual processing device and forwarding information related to the processing device are received from the processing device which provides an application service on a network, interface identifying information and forwarding information related to a processing device accessible on a network are retained, an access packet is received from a terminal that accesses the accessible processing device, access packet identifying information related to the access packet is compared with the interface identifying information and the forwarding information, the access packet is forwarded to the accessible processing device.

According to the invention, the access packet identifying information is compared with the interface identifying information and the forwarding information, whereby the access packet can be forwarded easily and accurately to the accessible processing device.

Further, in the invention, a hardware address of the processing device may be obtained as the forwarding information, and, when receiving the access packet, the access packet may be forwarded to the processing device on the basis of a hardware destination address added to the access packet.

According to the invention, the access packet is forwarded to the accessible processing device on the basis of the hardware address and the hardware destination address of the access packet, whereby the access packet can be forwarded easily and accurately to the accessible processing device.

Moreover, in the invention, a protocol address of the processing device may be obtained as the forwarding information, and, when receiving the access packet, the access packet may be forwarded to the processing device on the basis of a protocol destination address added to the access packet.

According to the invention, the access packet is forwarded to the accessible processing device on the basis of the protocol address and the hardware destination address of the access packet, whereby the access packet can be forwarded easily and accurately to the accessible processing device.

Still further, the protocol address of the processing device may be obtained as the forwarding information, and, when receiving the access packet, the access packet may be forwarded to the processing device in a way that encapsulates the access packet by use of a protocol header containing the protocol address.

According to the invention, the access packet is forwarded to the accessible processing device on the basis of the protocol address and the hardware destination address of the access packet, whereby the access packet can be forwarded easily and accurately to the accessible processing device.

Moreover, in the invention, the terminal having transmitted the access packet proven unable to forward as a result of the comparison, may be notified of an error.

According to the invention, the error notification is given to the access to the unaccessible processing device unable to receive the access packet, and hence unnecessary accesses causing the congestion, etc. can be reduced.

In the invention, the network may include a first network to which the interface providing device is connected and a second network to which the processing device is connected, and the first network and the second network may be different categories of networks.

Moreover, the network may include a first network to which the interface providing device is connected and a second network to which the processing device is connected, and the first network and the second network may be the same category of networks.

Still further, the invention may be a program for actualizing any one of the functions given above. Yet further, the invention may be a readable-by-computer storage medium stored with such a program.

Furthermore, the invention may be a device for actualizing any one of the functions given above.

### DESCRIPTION OF THE DRAWINGS

FIG. 1 is a block diagram showing an outline of an architecture of an interface providing device in an embodiment 1 of the invention.

FIG. 2 shows an example of a network architecture in which provision of a network application is actualized by processing devices according to the embodiment 1.

FIG. 3 is a block diagram showing an access packet forwarding process based on interface identifying information and forwarding information from the processing devices according to the embodiment 1.

FIG. 4 shows an example of a network architecture in which a routing protocol process according to an embodiment 2 is actualized by the processing device.

FIG. 5 is a block diagram of the interface providing device on the occasion of receiving the interface identifying information from the processing device when in the routing protocol process according to the embodiment 2.

FIG. 6 is a block diagram showing one example of the routing protocol process based on the interface identifying information and the forwarding information according to the embodiment 2.

FIG. 7 is a block diagram showing one example of a process of forwarding the packet on to the network from the processing device according to the embodiment 2.

### DETAILED DESCRIPTION OF THE INVENTION

### EMBODIMENT 1

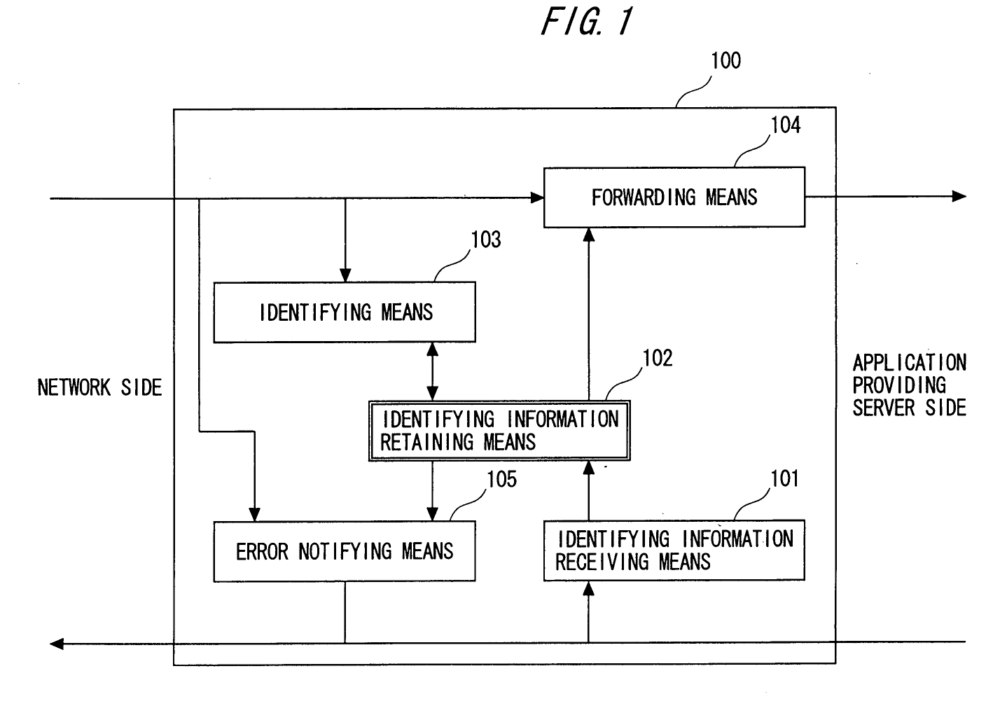

An interface providing device according to a preferred embodiment 1 of the invention will hereinafter be described with reference to the drawings in FIGS. 1 through 7.

<Architecture of Device>

FIG. 1 is a block diagram showing an outline of an architecture of an interface providing device 100 in the embodiment 1.

In the embodiment 1, the interface providing device 100 is actualized by use of a variety of information processing devices such as an existing server device, a packet processing device (e.g., a router), etc. Then, functions of the interface providing device 100 are actualized on the variety of information processing devices by introducing a processing method of the interface providing device 100 according to the invention as by programming this processing method, and so forth.

The interface providing device 100 in accordance with the embodiment 1 is constructed of the following components. The interface providing device 100 is constructed of an identifying information receiving means 101, an identifying information retaining means 102, an identifying means 103, a forwarding means 104 and an error notifying means 105.

The identifying information receiving means 101 receives, from a processing device (an application service providing server) for providing applications on a network, interface identifying information such as a tuple of an IP address “192.162.1.2” and a port number “80” by which one or more interfaces connected to a first network are associated with one or more processing devices connected to a second network, and pieces of forwarding information related to these processing devices. The identifying information receiving means 101 acquires concretely hardware addresses or protocol addresses of the accessible processing devices.

Note that the first network and the second network may be different networks in embodiments. Further, the first network and the second network may also be the same category of networks in embodiments.

The identifying information retaining means 102 retains the interface identifying information and the forwarding information that are related to the accessible processing devices on the network.

The identifying means 103 makes a comparison between access packet identifying information retained in an access packet from a terminal that accesses the application service, the interface identifying information and the forwarding information.

The forwarding means 104 forwards the access packet to the accessible processing device. Then, the forwarding means 104 forwards, specifically when receiving the access packet, the access packet to the processing device on the basis of a hardware destination address added to this access packet.

Note that the forwarding means 104 may, when receiving the access packet, forward the access packet to the processing device on the basis of a protocol destination address added to this access packet.

Further, this forwarding means 104, when having received the access packet, encapsulates this packet by use of the processing device address added to the access packet and the protocol destination address in a protocol header, and may thus forward the access packet to the processing device.

Then, the error notifying means 105, when receiving the access packet for a processing device unallowable to receive the access packet, notifies the terminal having transmitted this packet of an error.

<Network Architecture>

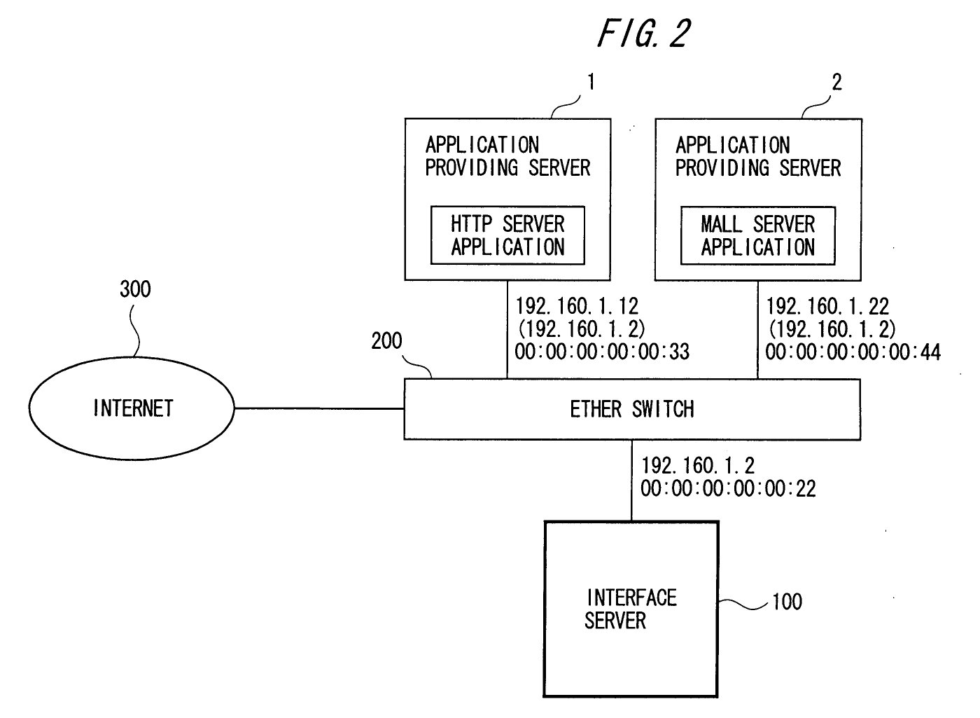

FIG. 2 shows an example of a network architecture in which the provision of the network application is actualized by the processing devices according to the embodiment 1. In the network according to the embodiment 1, the interface providing device 100 is connected via an Ethernet switch 200 to the processing devices 1 and 2. Further, the Ethernet switch 200 is connected to an existing network such as an Internet 300, etc. Then, terminals (unillustrated) that are provided with services from the network application are connected to the Internet 300.

In the embodiment 1, an HTTP (HyperText Transfer Protocol) service application runs on the processing device 1 for an interface “192.160.1.2” of the interface providing device 100. Moreover, a mail service application “192.160.1.2” runs on the processing device 2 for the interface “192.160.1.2” of the interface providing device 100. Then, the interface providing device 100 is previously stored with a MAC (Media Access Control) address “00:00:00:00:00:33” of the processing device 1. And the interface providing device 100 is previously stored and with a MAC address “00:00:00:00:00:44” of the processing device 2.

### PROCESSING EXAMPLE

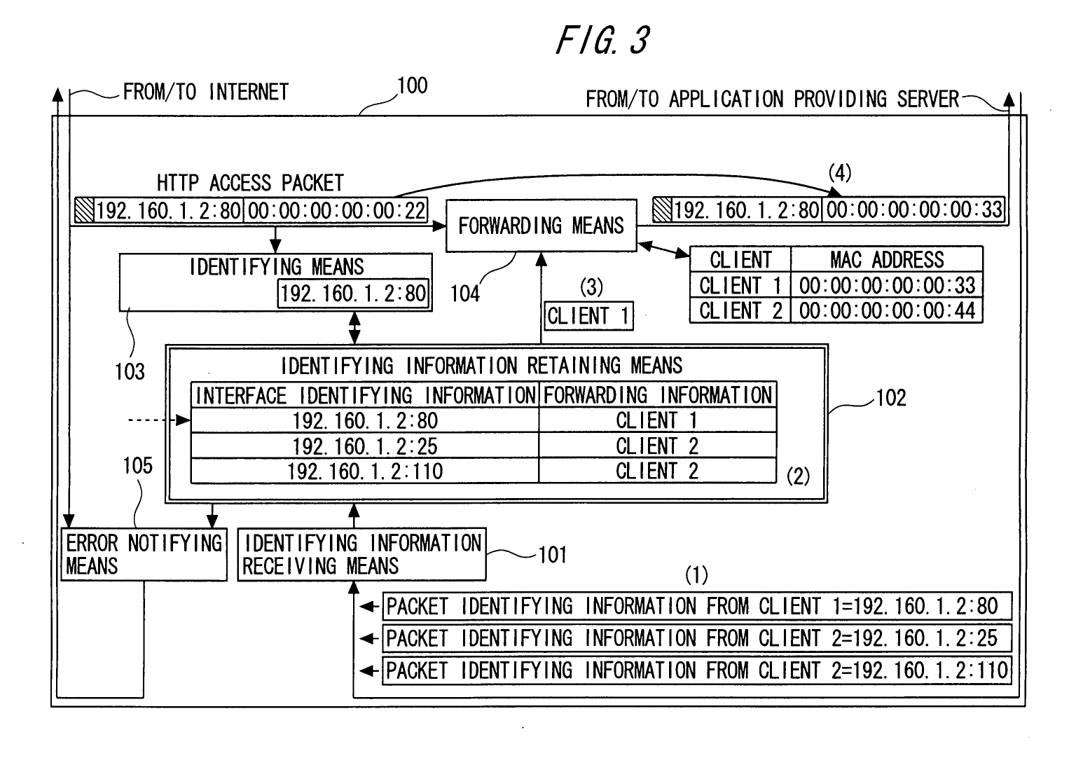

FIG. 3 is a block diagram showing an access packet forwarding process based on the interface identifying information and the forwarding information from the processing devices.

In FIG. 3, the HTTP service application is booted on the processing device 1. At this time, the processing device 1 notifies the interface providing device 100 of an IP (Internet Protocol) address “192.160.1.2” and a TCP (Transmission Control Protocol) port number “80” which is associated with the HTTP service((1) in FIG. 3).

The identifying information receiving means 101 judges that the processing device 1 has notified of the IP address “192.160.1.2” and the TCP port number “80”. Then, the identifying information receiving means 101 forwards the interface identifying information and a server name of the processing device 1 as a piece of forwarding information to the identifying information retaining means 102. The identifying information retaining means 102 retains the interface identifying information and the forwarding information ((2) in FIG. 3).

Similarly, the mail service application is booted on the processing device 2. At this time, the interface providing device 100 receives, from the processing device 2, the IP address “192.160.1.2” sent from the processing device 2, a port number “25” which is associated with SMTP (Simple Mail Transfer Protocol) as an electronic mail transfer protocol, and a port number “110” which is associated with POP 3 (Post Office Protocol 3) as a protocol for reading electronic mails from the terminals (unillustrated) ((1) in FIG. 3). At this time, the identifying information receiving means 101 forwards, to the identifying information retaining means 102, the IP address “192.160.1.2” sent from the processing device 2 and the SMTP port number “25”, and the IP address “192.160.1.2” of the processing device 2 and the POP 3 port number “110” as pieces of interface identifying information. Further, the identifying information receiving means 101 sets the server name of the processing device 2 as a piece of forwarding information. Then, the identifying information retaining means 102 is stored with the interface identifying information and the forwarding information of the processing device 2 ((2) in FIG. 3).

The terminals desiring for accessing to the application service via the network send access packets addressed respectively to the processing devices. For example, the interface providing device 100 receives the access packet from the terminal that accesses an HTTP service having the IP address “192.160.1.2”. At this time, the identifying means 103 of the interface providing device 100 obtains, from the access packet, the IP destination address “192.160.1.2.” and the TCP destination port number “80” as pieces of access packet identifying information. Then, the identifying means 103 compares the interface identifying information within the identifying information retaining means 102 with these pieces of access packet identifying information. The identifying means 103, when the interface identifying information are coincident with the access packet identifying information as a result of the comparison, identifies the information so that the access packet is to be forwarded to the processing device 1. Then, the identifying means 103 notifies the forwarding means 104 of this comparative result (3).

The forwarding means 104 rewrites a MAC destination address of the access packet into a MAC address value “00:00:00:00:00:33” of the processing device 1, and thus sends the address (4). Similarly, the forwarding means 104 sends the packet in a way that rewrites an address of each of the SMTP packet and the POP 3 packet of the mail service application, which is contained in the access packet from the terminal, into a MAC address “00:00:00:00:00:44” of the processing device 2.

Further, when the application service provided by each of the processing devices is terminated, the following procedures are made. To begin with, each of the processing devices notifies the identifying information receiving means 101 of the IP address and the TCP port number which is associated with the service on the processing device. Then, the identifying information receiving means 101 compares the IP address and the TCP port number with the interface identifying information information that are retained on the identifying information retaining means 102. The identifying information receiving means 101 deletes the interface identifying information and the forwarding information.

Given next is an explanation of processing by the interface providing device 100 in a case where the processing device corresponding to the access packet information according to the embodiment 1 is not started up, i.e., a case where the processing device is unable to receive the access packet.

An assumption is, for instance, that the HTTP service is before being started up or after being terminated. At this time, if the access packet from the terminal that accesses the HTTP service (the port number “80”) of the IP address “192.160.1.2” reaches the interface providing device 100, there are none of coincident values(IP address “192.160.1.2:80”) even when the identifying means 103 makes a comparison with the identifying information retained on the identifying information retaining means 102. In this case, the error notifying means 105 of the interface providing device 100 sends, to the terminal that has transmitted the access packet, an ICMP (Internet Control Message Protocol) Port Unreachable Message indicating that the access packet does not reach the processing device.

### EFFECTS OF EMBODIMENT 1

The following effects are acquired by actualizing the interface providing device 100 according to the embodiment 1.

According to the embodiment 1, the interface providing device 100 obtains the access packet identifying information from the access packet when in processing of the control protocol on the processing devices 1 and 2, when starting up and finishing the network application service and when setting up and releasing the connection, whereby the processing devices can be separated through every interface, every control process or every application service.

Moreover, according to the interface providing device 100 in the embodiment 1, the access packet can be forwarded depending on the accessibility of the processing device such as a start-up condition, etc. thereof.

Further, according to the interface providing device 100 in the embodiment 1, the access packet is forwarded to the target processing device via the proper route in the network, whereby networking faults such as congestion, etc. can be reduced.

Moreover, in accordance with the embodiment 1, the interface providing device 100 is capable of transmitting and receiving the packet related to the application service when providing the application service or when executing the new control processes of the application service on the processing devices 1 and 2.

Still further, according to the embodiment 1, even if the control process and the application service are changed to be provided by other processing devices due to failures of the processing devices 1 and 2, the interface providing device 100 is flexible to this change without through a manual operation of the operator.

### EMBODIMENT 2

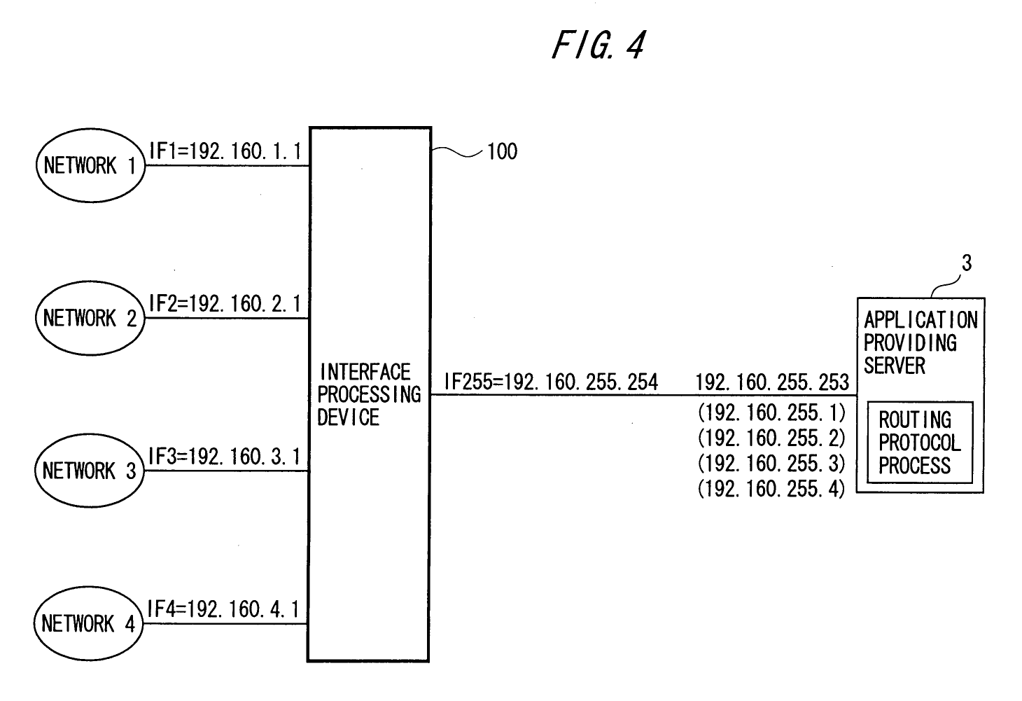

An embodiment 2 will hereinafter be described with reference to FIGS. 4 through 7. In the embodiment 1, the interface providing device executes the process of forwarding the access packet to the plurality of processing devices having the different applications. In the embodiment 2, the interface providing device of the invention executes a routing protocol process.

In the embodiment 2, other architecture and operation of the interface providing device 100 are the same as those in the embodiment 1. Explanations of the same architecture and operation as those in the embodiment 1 are omitted. Further, in the embodiment 2, FIGS. 1 through 3 are referred to according to the necessity.

<Network Architecture>

FIG. 4 shows an example of a network architecture in which a routing protocol process according to the embodiment 2 is actualized by the processing device. Note that BGP (Border Gateway Protocol) is employed as a routing protocol in the embodiment 2.

In the embodiment 2, the interface providing device 100 is connected to a processing device 3 for executing the routing protocol process, and to networks 1, 2, 3, 4 subjected to the execution of the routing protocol process.

### PROCESSING EXAMPLE

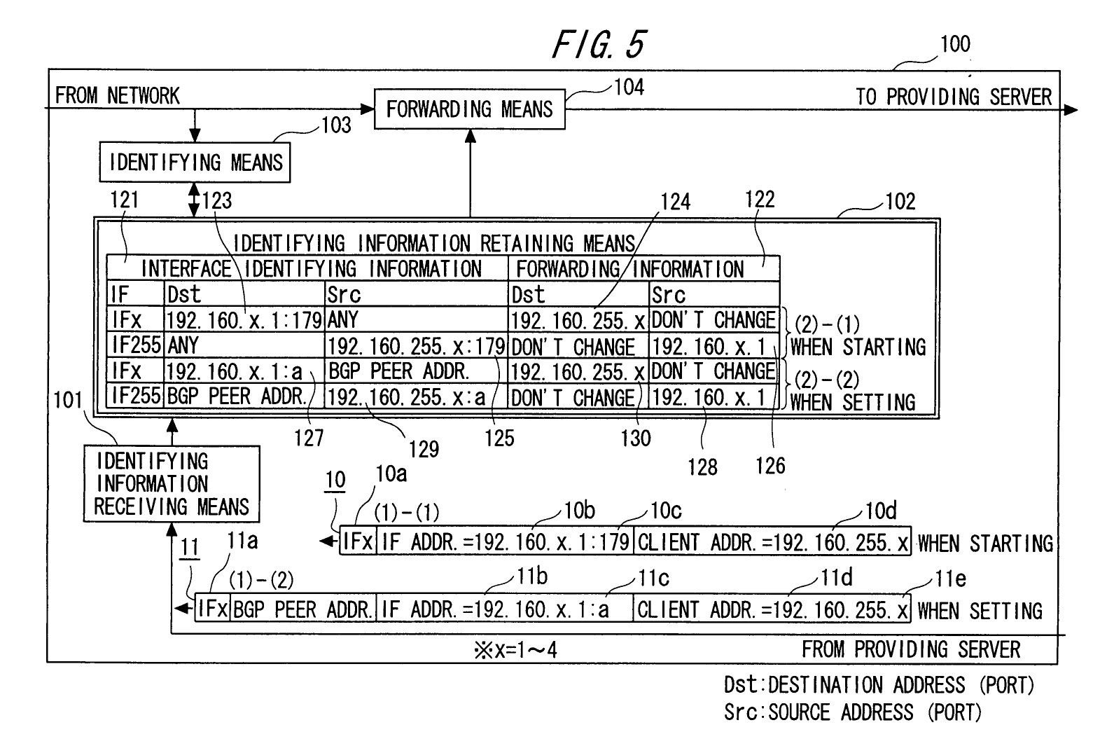

Next, one example of the routing protocol process according to the embodiment 2 will be explained with reference to FIGS. 5 through 7.

FIG. 5 is a block diagram of the interface providing device 100 on the occasion of receiving the interface identifying information from the processing device 3 when in the routing protocol process.

To begin with, the routing protocol process is started on the processing device 3, whereby the processing device 3 gets ready for receiving a BGP packet. When the routing protocol process is started, the interface providing device 100 receives, from the processing device 3, an interface name 10a (IFx), a tuple of an IP address 10b “192.160.x.1” and a TCP port number 10c “179” which is associated with BGP thereof, and a transmitting/receiving address 10d “192.160.255.x” of the processing device 3 with respect to each interface ((1)-(1) in FIG. 5).

The information received is stored on the identifying information retaining means 102. The identifying information retaining means 102 has an interface identifying information field 121. Further, the identifying information retaining means 102 has a forwarding information field 122 stored with rewriting information as a field associated with the interface identifying information field 121.

The identifying information receiving means 101 of the interface providing device 100 stores the interface name 10a (IFx), the IP address 10b “192.160.x.1” and the TCP port number 10c “179” notified as the interface information related to the interface in a destination address field 123 in the interface identifying information field 121 of the identifying information retaining means 102. Further, the identifying information receiving means 101 stores the interface name 10a (IFx), the IP address 10b “192.160.255.x” and the TCP port number 10c “179” notified as the interface information related to the interface in a source address field 125 on the processing device 3 (IF255).

The identifying information receiving means 101 stores the transmitting/receiving address 10d “192.160.255.x” of the processing device 3 in a destination address field 124 in a forwarding information field 122. Moreover, the identifying information receiving means 101 stores the transmitting/receiving address 10b “192.160.x.1” of the processing device 3 in a source address field 126 in the forwarding information field 122 related to the processing device 3 ((2)-(1)).

Further, the identifying information receiving means 101 of the interface providing device 100 receives, from the processing device 3, an interface name (IFx) 11a, an IP address 11b “192.160.x.1:a” and a TCP port number 11c “a” and the transmitting/receiving address 10d “192.160.255.x” of the processing device 3 ((1)-(2)), those are related to a setting phase of a BGP forwarding connection.

The identifying information receiving means 101, which has received these pieces of information, stores the interface name (IFx) 11a and, as an interface address, a tuple of the IP address 11b “192.160.x.1:a” and the TCP port number 11c “a” related to the setting phase of the BGP forwarding connection in a destination address field 127 in the interface identifying information field 121. Moreover, the identifying information receiving means 101 stores the interface name (IFx) 11a and the IP address 11b “192.160.x.1:a” related to the setting phase of the BGP forwarding connection in a source address field 128 in the forwarding information field 122 related to the processing device. 3 (IF255).

Further, the identifying information receiving means 101 stores the transmitting/receiving address 11d “192.160.255.x” of the processing device 3 as an address related to the setting phase of the BGP forwarding connection in a source address field 129 in the interface identifying information field 121 and in a destination address field 130 in the forwarding information field 122 ((2)-(2)).

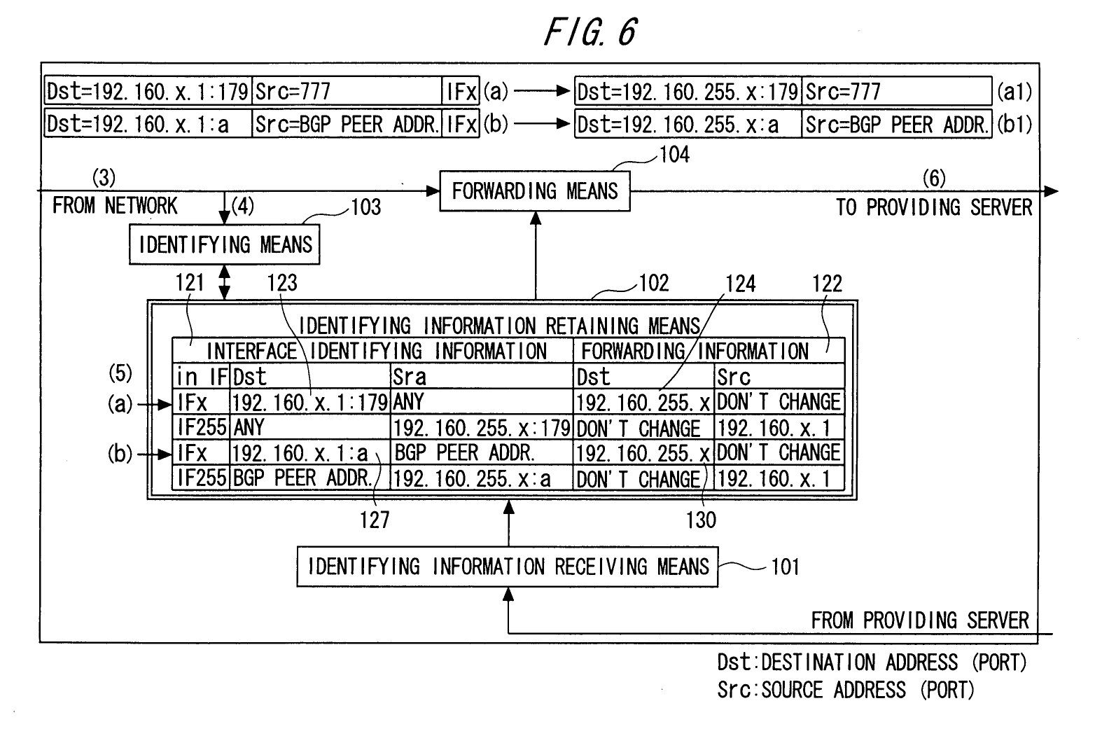

FIG. 6 is a block diagram showing one example of the routing protocol process based on the interface identifying information and the forwarding information in the embodiment 2.

As shown in FIG. 6, the interface providing device 100 receives the packet (a) from each of the interfaces (IFx) on the networks ((3) in FIG. 6). At this time, the identifying means 103 obtains the destination IP address “192.160.x.1” and the TCP port number “179” from the received packet (a) as the access packet identifying information of the packet (a) ((4)).

Then, the identifying means 103 compares the interface identifying information stored in the destination address field 123 in the interface identifying information field 121 of the identifying information retaining means 102 with the access packet identifying information of the packet (a) ((5)). As a result of this comparison, the destination address of the packet (a) coincident with the interface identifying information in the destination address field 123, is rewritten by the forwarding means 104 into the IP address “192.160.255.x” in the destination address field 124 in the forwarding information field 122. Then, the forwarding means 104 forwards the access packet (a1), of which the IP address has been rewritten, to the interface with the processing device 3 ((6)).

Note that the forwarding process of the packet (b) related to the setting phase of the BGP forwarding connection is executed in the same way as the process of the packet (a) has been executed. Namely, the access packet identifying information of the packet (b) from on the network is compared with the destination address in the destination address field 127 in the BGP forwarding interface identifying information field 121 of the identifying information retaining means 102. Then, the packet (b) proven coincident as a result of the comparison, after its destination address has been rewritten by the forwarding means 104 into a destination address in the destination address field 130 in the forwarding field 122, is forwarded as a packet (b1) to the processing device 3.

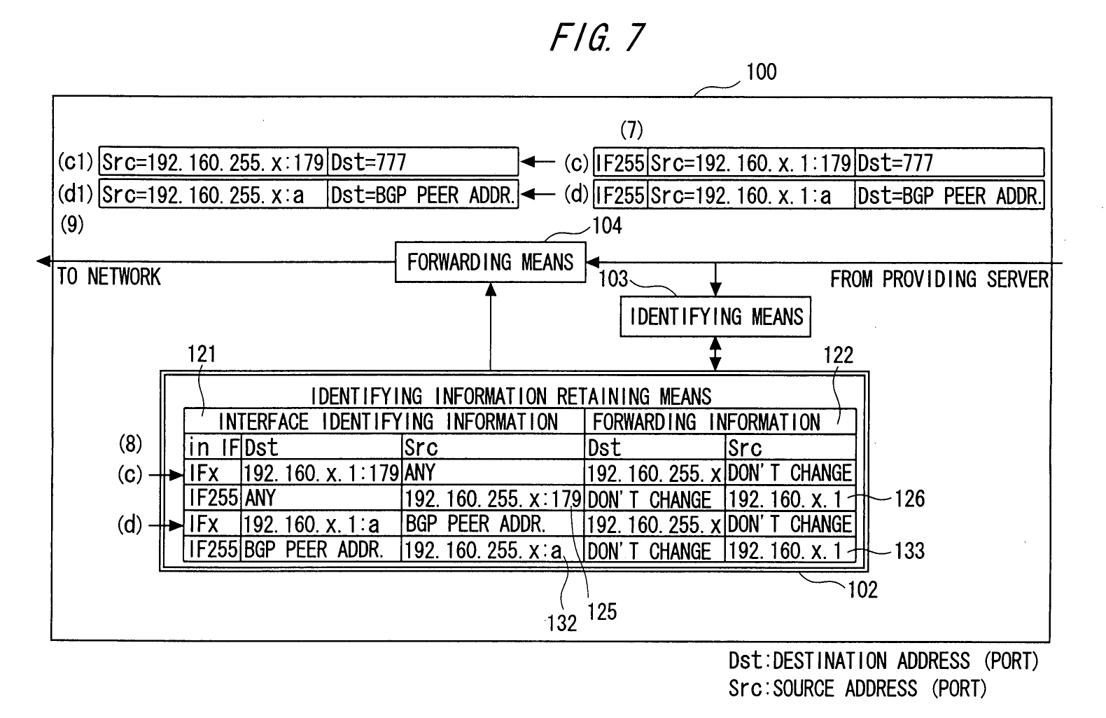

FIG. 7 is a block diagram showing one example of the process of forwarding the packet on to the network from the processing device 3.

As shown in FIG. 7, the interface providing device 100 receives a packet (c) forwarded from the interface with the processing device 3. At this time, the identifying means 103 compares the interface identifying information of this packet (c) with the interface identifying information related to the processing device 3 (IF255) that is stored in the source address field 125 in the interface identifying information field 121 of the identifying information retaining means 102 ((8)).

As a result of this comparison, the IP address of the packet (c) of which the interface identifying information is coincident with the destination address in the destination address field 130, is rewritten by the forwarding means 104 into a source address in a source address field 126 in the forwarding information field 122. Then, the forwarding means 104 forwards the packet (c1) with its IP address rewritten to the interface with the network ((9)).

It is noted that, the forwarding process of the packet (d) related to the setting phase of the BGP forwarding connection is executed in the same way as the process of the packet (c) described above has been done. Namely, the access packet identifying information of the packet (d) from the processing device 3 is compared with the destination address in the destination address field 132 in the BGP forwarding interface identifying information field 121 of the identifying information retaining means 102. Then, the address of the packet (b) becoming coincident as a result of the comparison is rewritten by the forwarding means 104 into a destination address in the destination address field 133 in the forwarding information field 122, and this packet (b) is forwards as a packet (d1) on to the network.

Further, in the embodiment 2, when in a connection releasing phase and when terminating the routing process, the processing device 3 notifies the interface providing device 100 of the same interface identifying information and forwarding information as those when in the setting phase and when started up. Then, the identifying information receiving means 101 deletes corresponding pieces of interface identifying information and forwarding information stored on the identifying information retaining means 102.

### EFFECTS OF EMBODIMENT 2

The following effects are acquired by actualizing the interface providing device 100 according to the embodiment 2.

According to the interface providing device 100 in the embodiment 2, the connection to the network is established through every interface, and hence the network can be identified by identifying the interface.

According to the interface providing device 100 in the embodiment 2, the routing protocol process can be executed depending on the accessibility of the processing device such as the starting state, etc. Therefore, according to the embodiment 2, the access packet can be forwarded easily and accurately.

Further, according to the interface providing device 100 in the embodiment 2, the access packet is forwarded to the target processing device via the proper route by executing the routing protocol process, whereby networking faults such as congestion, etc. can be reduced.

### MODIFIED EXAMPLES

In the embodiments, the interface providing device of the invention has been discussed by way of one example of mainly the authentication information, however, the invention can be broadly embodied for other interface providing devices without being limited to the embodiments 1 and 2.

The assumption in the embodiment 1 is that the interface providing device 100 knows beforehand the MAC addresses of the processing devices 1 and 2, however, the interface providing device of the invention is not limited to this scheme. Namely, in the embodiment 1, the processing devices 1 and 2 may notify the interface providing device 100 of the MAC addresses of the processing devices 1 and 2.

Further, in the embodiment 1, the interface providing device 100 may previously store the IP addresses or may also dynamically obtain the IP addresses in accordance with the notification in (1) in FIG. 3.

Then, in the embodiment 1, the interface providing device 100 may dynamically obtain a piece of information for identifying the interface by use of Address Resolution Protocol (ARP).

Further, there may be a plurality of interfaces of the interface providing device 100 in the embodiment. Namely, the interface providing device 100 may separate the interfaces into the interface with the Internet and the interface with the processing device.

Moreover, according to the invention, the interface providing device may allocate the interfaces to each of the processing devices.

Further, there may be a plurality of interfaces with the Internet, wherein a different processing device may exist per interface for the same application service.

Still further, in the embodiment 1, the HTTP service application and the mail service application have been exemplified as the application services started on the processing devices 1 and 2, however, the application services are not limited to those in the interface providing device of the invention. For example, the application services processed by the interface providing device of the invention can be applied to a variety of existing network applications for transferring files and providing news.

Moreover, in the embodiment 1, the processing device notifies of the IP address and the TCP port number when starting up or terminating the application service, however, the notification is not limited to this timing in the interface providing device of the invention. That is, in the interface providing device of the invention, the notification of the IP address and the TCP port number may also be given when setting up or releasing the TCP connection.

The embodiment 2 has exemplified the one-to-one scheme of the processing device and the interface providing device, however, the scheme is not limited to this in the interface providing device of the invention. Namely, according to the invention, a plurality of processing device may exist for every interface of the interface providing device.

Moreover, in the embodiment 2, one single processing device may control a plurality of interface providing devices 100. Further, in the embodiment 2, the interface with the network of the interface providing device 100 and the interface with the processing device are separated but may also be the same.

Yet further, in the embodiment 2, the BGP has been exemplified as the routing protocol to be used, however, the protocol is not confined to the BGP in the interface providing device of the invention. Namely, other routing protocols may also be available for use in the interface providing device of the invention. Moreover, in the interface providing device of the invention, a suite of these routing protocols may coexist, and the processing devices may be separated according to the protocol or the interface.

Further, in the embodiment 2, the routing protocol process may be applied for the network applications as discussed in the embodiment 1, or those network applications may coexist.

In the embodiment 2, the transmitting/receiving IP address of the processing device 3 and the IP address on the network side of the interface providing device 100, are received from the processing device 3 in the starting, finishing, setting and releasing procedures, however, the receipt of the address is not limited to this mode in the interface providing device of the invention. Namely, in the interface providing device of the invention, the IP address is statically set beforehand or may be previously received in a different phase.

In the embodiment 2, the IP address is translated and thus forwarded, however, the forwarding of the IP address is not limited to this scheme in the interface providing device of the invention. That is, in the interface providing device of the invention, the packet may be encapsulated by use of the IP header and may thus be forwarded. In this case, according to the embodiment 2, the interface (192.160.x.1) on the network side and the transmitting/receiving address (192.160.255.x) of the processing device, are used for the address translation, however, the packet may also be encapsulated by use of the interface (192.160.255.254) on the side of the processing device and the real address (192.160.255.253) of the processing device.

1. An interface providing device comprising:
identifying information receiving unit receiving, from a processing device providing an application service on a network, interface identifying information related to the individual processing device and forwarding information related to the processing device;
identifying information retaining unit retaining the interface identifying information and the forwarding information related to a processing device accessible on the network;
access packet receiving unit receiving an access packet from a terminal that accesses the accessible processing device;
identify unit comparing access packet identifying information related to the access packet with the interface identifying information and the forwarding information; and
forwarding unit forwarding the access packet to the accessible processing device.

2. An interface providing device according to claim 1, wherein the identifying information receiving unit obtains a hardware address of the processing device as the forwarding information, and the forwarding unit, when receiving the access packet, forwards the access packet to the processing device on the basis of a hardware destination address added to the access packet.

3. An interface providing device according to claim 1, wherein the identifying information receiving unit obtains a protocol address of the processing device as the forwarding information, and the forwarding unit, when receiving the access packet, forwards the access packet to the processing device on the basis of a protocol destination address added to the access packet.

4. An interface providing device according to claim 1, wherein the identifying information receiving unit obtains the protocol address of the processing device as the forwarding information, and the forwarding unit, when receiving the access packet, forwards the access packet in a way that encapsulates the access packet by use of a protocol header containing the protocol address.

5. An interface providing device according to claim 1, further comprising error notifying unit giving an error notification to the terminal having transmitted the access packet has proven unable to forward as a result of the comparison by the identifying unit.

6. An interface providing device according to claim 1, wherein the network includes a first network to which the interface providing device is connected and a second network to which the processing device is connected, and the first network and the second network are different categories of networks.

7. An interface providing device according to claim 1, wherein the network includes a first network to which the interface providing device is connected and a second network to which the processing device is connected, and the first network and the second network are the same category of networks.

8. An interface providing method comprising:
receiving, from a processing device for providing an application service on a network, interface identifying information related to the individual processing device and forwarding information related to the processing device;
retaining interface the identifying information and the forwarding information related to a processing device accessible on the network;
receiving an access packet from a terminal that accesses the accessible processing device;
comparing access packet identifying information related to the access packet with the interface identifying information and the forwarding information; and
forwarding the access packet to the accessible processing device.

9. An interface providing method according to claim 8, further comprising: obtaining a hardware address of the accessible processing device as the forwarding information; and
forwarding, when receiving the access packet, the access packet to the processing device on the basis of a hardware destination address added to the access packet.

10. An interface providing method according to claim 8, further comprising:
obtaining a protocol address of the processing device as the forwarding information; and
forwarding, when receiving the access packet, the access packet to the processing device on the basis of a protocol destination address added to the access packet.

11. An interface providing method according to claim 8, further comprising:
obtaining the protocol address of the processing device as the forwarding information; and
forwarding, when receiving the access packet, the access packet in a way that encapsulates the access packet by use of a protocol header containing the protocol address.

12. An interface providing method according to claim 8, further comprising giving an error notification to the terminal having transmitted the access packet proven unable to forward as a result of the comparison by the identifying unit.

13. An interface providing method according to claim 8, wherein a first network and a second network are different categories of networks.

14. An interface providing method according to of claims 8, wherein a first network and a second network are the same category of networks.
